(19) United States
(12) Patent Application Publication
(10) Pub. No.: US 2006/0210730 A1
(43) Pub. Date: Sep. 21, 2006

(54) Inkjet recording element comprising particles and polymers

(76) Inventors: Andrew M. Howe, Watford (GB); Robin D. Wesley, Ruislip (GB)

Correspondence Address: PATENT LEGAL STAFF, EASTMAN KODAK COMPANY, 343 STATE STREET, ROCHESTER, NY, 14650-2201, US

(21) Appl. No.: 10/553,341

(22) PCT Filed: Apr. 1, 2004
(86) PCT No.: PCT/GB04/01381

§ 371 Date: Oct. 17, 2005

(30) Foreign Application Priority Data
Apr. 17, 2003 (GB) 0308937.2

(51) Int. Cl. B41M 5/00

(52) U.S. Cl. 428/32.24

(57) ABSTRACT

The invention provides an inkjet recording element comprising a support having thereon an image-receiving layer, said inkjet recording element containing colloidal particles having a charged or chargeable surface and having associated therewith at least two polymers having ionised or ionisable groups thereon, wherein one of those polymers has ionised or ionisable groups of opposite charge to that of the surface of the colloidal particles and another of those polymers has ionised or ionisable groups the same as that of the surface of the colloidal particles. When printed with ink the element can impart good image stability, has a short dry time, can give any required gloss, provides good optical density and is suitable for use with a wide range of inks.

### FIELD OF THE INVENTION

The invention relates to an inkjet recording element comprising colloidal particles having ionised or ionisable surface groups and polyelectrolyte species of different charge types.

### BACKGROUND OF THE INVENTION

In a typical inkjet et recording or printing system, ink droplets are ejected from a nozzle at high speed towards a recording element to produce an image on the element. The ink droplets, or recording liquid, generally comprise a recording agent, such as a dye or pigment, and a large amount of solvent. The solvent, or carrier liquid, typically is made up of water and an organic material such as a monohydric alcohol, a polyhydric alcohol or mixtures thereof

An inkjet recording element typically comprises a support having on at least one surface thereof an ink-receiving or image-receiving layer, and includes those intended for reflection viewing, which have an opaque support, and those intended for viewing by transmitted light, which have a transparent support.

An important characteristic of inkjet recording elements is their need to dry quickly after printing. To this end, porous recording elements have been developed which provide nearly instantaneous drying as long as they have sufficient thickness and pore volume to effectively contain the liquid ink. For example, a porous recording element can be manufactured by a coating process in which a particulate-containing coating formulation is applied to a support and is dried. Porous receivers are usually comprised of colloidal particles with polymeric binders and these absorb ink rapidly through pores that exist between the particles. However, the image stability in these systems is poor when exposed to environmental ozone.

Non-porous receivers are usually comprised of one or more polymer layers that have been coated from solution; because there are no voids in these structures, they must swell to absorb the ink. Swelling slows the absorption and so prints smudge easily after printing. However, once dried, printed images are often stable when exposed to light or ozone.

Polyelectrolyte multilayers (hereinafter PEMs) consist of particles with two or more layers of adsorbed polyelectrolyte species. Each polymer layer is of opposite charge to the previous layer and the polymers are associated sequentially via electrostatic attraction. PEMs are well known in the literature and a range of uses has been proposed for these materials including biosensors or as intermediates in the production of controlled-release drug delivery systems.

Most published PEM technology concerns ‘layer-by-layer coating’ i.e. macroscopic coatings, usually produced by dip coating. WO 96/18498 describes using layer-by-layer adsorption for biomedical applications, wherein the layers are adsorbed on macroscopic, polymeric substrates by dip coating. U.S. Patent Application Publication No. 2001/0048975 discloses a similar approach, but two polyelectrolytes of opposite charge are applied in a single coating process by dipping a macroscopic surface (such as a contact lens) into a pH controlled solution containing two polyelectrolytes. The dip method is not straightforwardly adapted to colloidal particles.

U.S. Patent Application Publication No. 2000/0002358 describes a method whereby a suspension of core/shell nanoparticles is produced. The shells consist of an inert material which is used to isolate the functional cores from their neighbours. These nanoparticles are then coated in a multi stage layer-by-layer dip coating process onto a macroscopic (i.e. not colloidal) substrate to be used for example as magnetic storage devices.

U.S. Patent Application Publication No. 2002/0187197 and U.S. Pat. No. 5,705,222 describe PEMs on the surface of colloidal particles. These may be prepared from very dilute systems and always require dialysis or sedimentation steps after each polyelectrolyte addition. The extra steps that are necessary between every addition of polymer would preclude their use in economically viable paper coating processes. There is no disclosure of applicability to inkjet systems. U.S. Pat. No. 6,417,264 and German patent application DE 100 33 054 A1 describe methods for adding a single layer of polycation to silica particles with an anionic surface charge using high pressure mixing. A polyelectrolyte of only one charge type is used. This combination of a single polyelectrolyte-type with colloidal particles may be used in inkjet receiving layers.

U.S. Patent Application Publication Nos. 2002/0149656 and 2003/0021983 describe the use of PEMs on colloidal particles in inks and other recording media for printing onto substrates. These publications describe recording media containing composites of at least one polymer with colloidal particles. The composites include colorants or other functional additives. The recording media are applied to a variety of substrates to provide colour to the substrate, to modify the surface texture of the substrate or to provide other aesthetic factors. There is no indication that these composites of particles and at least one polymer could be coated to form part of an inkjet receiving layer; nor that the images received into that layer would exhibit enhanced density or stability to ambient ozone; nor that the receiving layer would be able to provide rapid drying. There is no disclosure of any commercially-viable method for making inkjet receiver layers of practical thickness.

### PROBLEM TO BE SOLVED BY THE INVENTION

There is a need to provide an inkjet recording element that, when printed with ink can impart good image stability, has a short dry time, can give any required level of gloss, provides good optical densities and is suitable for use with a wide range of inks.

### SUMMARY OF THE INVENTION

According to the present invention there is provided an inkjet recording element comprising a support having thereon at least one image-receiving layer, said inkjet recording element containing colloidal particles having a charged or chargeable surface and having associated therewith at least two polymers having ionised or ionisable groups thereon, wherein one of those polymers has ionised or ionisable groups of opposite charge to that of the surface of the colloidal particles and another of those polymers has ionised or ionisable groups the same as that of the surface of the colloidal particles.

In a further aspect of the invention there is provided a method of coating a substrate comprising the steps of

(a) providing colloidal particles having a charged or chargeable surface;

(b) combining the colloidal particles with at least two polymers having ionised or ionisable groups thereon, one of those polymers having ionised or ionisable groups of opposite charge to that of the surface of the colloidal particles and another of those polymers having ionised or ionisable groups the same as that of the surface of the colloidal particles, to provide a coatable formulation;

(c) applying the formulation to the substrate to form a coating thereon and

(d) drying the resultant coating.

In another aspect there is provided the use of the colloidal particles and associated polymers as hereinbefore described for the preparation of an inkjet recording element providing enhanced image stability and a short dry time.

In yet another aspect of the invention there is provided an inkjet printing method comprising the steps of

(a) providing an inkjet printer that is responsive to digital data signals;

(b) loading the printer with the inkjet recording element described above;

(c) loading the printer with an inkjet composition; and

(d) printing on the inkjet recording element using the inkjet composition in response to the digital data signals.

### ADVANTAGEOUS EFFECT OF THE INVENTION

The colloidal particles and associated polymers can be coated and dried to form an inkjet recording element that has the required glossiness, is touch-dry after inkjet printing and provides an environment in which the dyes show high stability to ambient ozone.

### BRIEF DESCRIPTION OF TIE DRAWINGS

FIG. 1 is a plot of total polyelectrolyte concentration against zeta potential, showing the zeta charge potential of anionic silica particles on sequential addition of polyelectrolytes, wherein

(a) + indicates the addition of varying amounts of 2 kD polyethyleneimine to silica;

(b) □ indicates the addition of 200 kD sodium polystyrene sulfonate to a silica/2 kD polyethyleneimine composite; and

(c) ● and (d) ◯ indicate composites containing exactly equal amounts of silica, 2 kD polyethyleneimine and 200 kD sodium polystyrene sulfonate, with varying amounts of 750 kD polyethyleneimine. However in

(c) ● three polymers were added to silica in three sequential steps whilst in

(d) ◯ a mixture of 200 kD sodium polystyrene sulfonate with 750 kD polyethyleneimine was added to a silica/2 kD polyethyleneimine composite.

### DETAILED DESCRIPTION OF THE INVENTION

The colloidal particles useful in the invention have surface ionised or ionisable groups such that the particle has a net anionic or cationic charge. Particles dispersed in a liquid may gain a surface charge through the presence of dissociable groups at the surface by losing a charged species into the bulk liquid, or by adsorption of charged species such as ions, ionic surfactants or ionic polymers in a manner familiar to those skilled in the art or may gain the charge from the presence of lattice imperfections. Thus the ionised or ionisable groups may be an intrinsic part of the particle core, or may be adsorbed, chemically grafted or otherwise attached to the surface. One skilled in the art can readily determine the conditions favourable for inducing an appropriate charge onto various inorganic or organic particles in such a way that they can be used in the present invention.

As used herein the term colloidal particle is defined as a particle wherein one dimension is from 1 nm to 10 μm and hence includes, but is not limited to, a nanoparticle. The colloidal particles are generally solid, and may comprise a ‘core’ structure and they are not deformable when in the inkjet recording element. Normally they do not impart a colour, other than white, to the element. The particles may be of any shape but are generally spherical, although they may also be crystalline, rod-, disc- or tube- shaped or pre-aggregated, such as fumed aluminium oxide or a silicon oxide (hereinafter silica).

The equivalent spherical diameter of the colloidal particles, hereinafter ESD, is the diameter of a sphere having a volume equal to the projected volume. This may be from about 0.01 to about 10 μm, preferably from about 0.02 to about 10 μm, more preferably from about 0.04 to about 0.5 μm. Techniques for measuring particle ESD include, but are not limited to, electron microscopy, photon correlation spectroscopy, static light scattering, coulter counter, acoustic sizing techniques, sedimentation or particle size estimate based upon a measured surface area for particles of defined geometry, as measured by, for example, the use of a nitrogen absorption isotherm technique. The ESD of the particle can be selected appropriately to the need: for example increase in ESD will reduce dry time: a decrease in ESD will increase glossiness.

The colloidal particles may be inorganic or organic or may comprise composite materials, the selection of which will be apparent to one of ordinary skill in the relevant art. Any inorganic particles may be used, such as, for example, a silica, silica surface-treated, for example with aluminium and its oxides or molecules with amine or ether groups, an aluminium oxide, a clay such as, for example, kaolin, calcined clay, montmorillonite or talc, a magnesium silicate, barium sulfate, calcium carbonate, calcium oxide, zinc oxide, magnesium oxide, titanium oxide, zirconium oxide, zinc sulfide, a sulfate, carbonate, bicarbonate, oxide, hydroxide, nitrate, boride, carbide, silicide, nitride, phosphide, arsenide, sulfide, selenide, telluride, fluoride, chloride, bromide, or iodide, or halide combination thereof, or an inorganic organic composite such as an organo clay. Such materials tend to adopt a negative surface charge at high pH and a positive surface charge at low pH.

Organic particles suitable for use in the invention may include polymeric materials such as, for example, a poly(styrene), poly(methylstyrene), polyurethane, polyacrylate, nylon, polyester, polyamide or poly(melamine formaldehyde) or a combination, derivative or copolymer thereof. These colloidal particles may obtain a surface charge by the inclusion of a chargeable monomer or initiator group or by the adsorption of a charged surfactant or polymer.

When the particles are negatively charged, i.e. are anionic, they may suitably comprise a silica, surface-treated silica, zinc oxide, zirconium oxide, aluminium oxide, a titanium oxide, barium sulfate or a clay such as, for example, kaolin, calcined clay, montmorillonite or talc. When they are positively charged, i.e. are cationic, they may suitably include a silica, surface-treated silica, aluminium oxide, zinc oxide, magnesium oxide or calcium carbonate.

Preferred colloidal particles for use in the invention are white or ‘near-white’ although the invention is not to be considered to be so limited. They may more preferably include a silica, aluminium oxide, talc, barium sulfate, calcium carbonate, kaolin or calcined clay. Most preferably the colloidal particles for use in the invention may comprise a silica, such as silica gel, hydrous silica, fumed silica or colloidal silica The surface of a silica particle may be modified by a range of materials, for example, molecules containing amines or ethers or by the inclusion of aluminium and its oxides. The modification of the silica surface may be used to change the zeta potential in a manner predictable to one skilled in the art.

Polyelectrolytes, generally, are understood as polymers having charged or chargeable groups, which can be a component or substituent of the polymer chain. Usually, the number of these charged or chargeable groups in polyelectrolytes is so large that the polymers (also called polyions) are water-soluble. The term ‘polyelectrolytes’ is understood in this context to cover also polymers wherein the concentration of charged or chargeable groups within the polymer is not sufficient for water-solubility. However, the polymers preferably comprise water-soluble polyelectrolytes. The terms “charged polymer”, “chargeable polymer” and the term “polyelectrolyte” are, in general, used interchangeably herein to include, without limitation, any polymer or oligomer that contains charged or chargeable groups. Polymers with both anionically and cationically charged or chargeable groups are referred to as polyampholytes and these are specifically included within the term ‘polyelectrolyte’. Suitable polyelectrolytes according to the invention are also biopolymers, modified biopolymers and biopolymer derivatives.

In accordance with this invention at least two polymers, preferably two or three, are associated with the colloidal particles, either sequentially and/or as a mixture. Any charged polymer can be used that has a positive charge, a negative charge or can be induced to carry a charge to provide a net positive or negative charge, for example by adjusting the solution pH.

Synthetic polymers include but are not limited to those that contain monomers which are cationic or which can gain a cationic charge, for example: allylamine, ethyleneimine, vinylamine, 2-vinylpyridine, 4-vinylpyridine, diallyldimethylanmmonium, 2-vinylpiperidine, 4-vinylpiperidine, 2-butyl-methacryloxyethyltrimethyl ammonium, 4-vinybenzyltrimethylammonium, N,N′-bis 2,2,6,6-tetramethyl-4-piperidine, dimethyliminomethylene, butyl acrylate methacryloxyethyltrimethylammonium and their salts and derivatives. These polymers may be homopolymers of the above monomers or may be copolymers that consist of the above monomers.

Synthetic polymers include but are not limited to those that contain monomers which are anionic or which can gain an anionic charge, for example: a styrenesulfonic acid, vinylsulfonic acid, acrylic acid, 2-acrylamido-2-methyl-propane sulfonic acid, maleic anhydride, maleic acid, ethylene sulfonic acid, methacrylic acid, vinylsulfuric acid, ethylenephosphonic acid, maleic acid, 2-methacryloxyethane-1-sulfonic acid, 3-methacryloxyethane-1-sulfonic acid, vinylbenzoic acid, 3-(vinyloxy)propane-1-sulfonic acid, 4-vinylphenol, 4-vinylphenylsuiliric acid, 4n-vinylsuccinamic acid and their salts and derivatives. These polymers may be homopolymers of the above monomers or may be copolymers that consist of the above monomers.

Synthetic polyampholytes include but are not limited to those that comprise one or more of the anionic and one or more of the cationic monomers listed above or may contain monomers which are themselves amphoteric, for example betaines, sulfobetaines and amino acids.

Biopolymers and their derivatives may include but are not limited to polysaccharides such as chitin, chitosan, xanthan, alginates, carageenans, gummi arabicum, nucleic acids, pectins, proteins such as casein, albumin, protein derivatives and protein degradation products such as gelatins, modified gelatins and gelatin derivatives, as well as chemically modified biopolymers such as carboxymethyl cellulose, carboxyalkyl celluloses, other cellulose derivatives and lignin sulfonates.

Particularly preferred polymers which are cationic or may gain a cationic charge for use in the invention include polyethylenimine (hereinafter PEI), poly(4-vinylpyridine) (hereinafter P4VP), and a cationically modified polyvinyl alcohol (hereinafter CPVA).

Particularly preferred polymers which are anionic or may gain a anionic charge for use in the invention include sodium polystyrene sulfonate (hereinafter PSS), others salts of polystyrene sulfonate, copolymers consisting of styrene sulfonates with other monomers, copolymers consisting of styrene sulfonates and maleic acid or anhydride monomers, polyacrylic acid (hereinafter PAA), poly 2-acrylamido-2-methylpropane sulfonate and an anionically modifed polyvinyl alcohol (hereinafter APVA).

A particularly preferred biopolymer for use in the invention is the polyampholyte gelatin, a modified gelatin or a gelatin derivative.

Depending on the functionality required, a polymer of appropriate molecular weight can be selected. For example, for mechanical strength of the dried coating a molecular weight of greater than 20 kD may be suitable. Additionally, for reduction in viscosity of the coating or intermediate formulations, a molecular weight of less than 50 k would normally be used. It may be possible to chemically modify the polymers used so that they include groups which can stabilise dyes against light fade or ozone fade.

In one embodiment a first polymer associated with the colloidal polymer may contain groups of charge opposite to those on the surface of the particle. Thus the addition of a polycation such as, for example, PEI will reduce or reverse the sign of the zeta potential of an anionic colloidal particle to positive, and addition of a polyanion thereto will cause a further reversal of zeta potential. Alternatively the addition of a polyanion such as, for example PSS, will reduce or reverse the zeta potential of a cationic colloidal particle to negative, and addition of a polycation thereto will cause a further reversal of zeta potential.

In general, the degree to which the zeta potential of the particles is modified by the associated polymer or polymers depends upon the composition of the polymers, the concentration of the polymers relative to the surface area of the particles and other factors such as the pH. It is not always necessary nor desirable for each polyelectrolyte to reverse the sign of the zeta potential. If a polyampholyte such as gelatin is the first polymer, the surface charge of the colloidal particle may be either cationic or anionic.

The zeta potential of the particle with the associated polyampholyte depends upon the composition of the polyampholyte, the concentration of the polyampholyte relative to the surface area of the particles and the pH relative to the isoelectric point of the polyampholyte. Where there is a polyampholyte associated with the particle, a polymer containing positive or negative chargeable groups may be associated with the colloidal particle-polyampholyte composite.

It is not always necessary to add each polyelectrolyte in a separate step. In some cases it may be advantageous to pre-mix polyelectrolytes before addition to suspensions comprising the colloidal particles. It is also a feature of this invention that there is no need for a step to separate the particles from excess polyelectrolyte, for example between each subsequent addition of polyelectrolyte or polyelectrolytes. A method to separate the excess polyelectrolyte would be for example dialysis, ultrafiltration or sedimentation of the particles followed by removal of the liquid phase.

The total weight of polymer based upon the volume of the colloidal particles, may comprise from about 1 to about 500%, preferably from about 5 to about 100%, more preferably from about 10 to about 40%. The amount of poly-electrolyte required depends on the surface area of the colloidal particles. The figures above are given for spherical particles of 70-80 nm in diameter. For particles with one or more dimensions smaller than 70 nm, higher ranges of total polyelectrolyte concentrations may be desirable.

The ratio of polymer or polymers consisting of groups of one charge to that of the polymer or polymers consisting of groups of the opposite charge is normally not limited; however in a preferred embodiment the ratio should not be more than about 100 to 1, more preferably 30 to 1 and most preferably 5 to 1.

The colloidal particles and associated polymers for use in the invention are normally located in one or more of the image-receiving layers, which may be part of a single or multipart structure. The particles and associated polymers may also or alternatively be present in an overcoat layer or an interlayer within the element.

The thickness of the one or more layers containing the colloidal particles and associated polymers may range from about 1 to about 80 μm, preferably from about 2 to about 40 μm, more preferably from about 3 to about 30 μm. The coating thickness required is determined through the need for the coating to act as a sump for absorption of ink solvent and the need to hold the ink near the coating surface.

In addition to the image-receiving layer and overcoat and interlayer, when present, the recording element may also contain a base layer, next to the support, the primary function of which is to absorb the solvent from the ink, but may also contain the colloidal particles and associated polymers. Materials useful for this layer include particles, polymeric binder and/or crosslinker.

In a preferred embodiment of the invention, the image-receiving layer may contain a binder, in particular a polymeric binder, in an amount sufficient to enhance, where required, mechanical stability or gloss of the image-receiving layer. However it is a feature of the invention that a binder is not always necessary to achieve the stated objects of the invention. The binder may be a hydrophilic polymer such as, for example, a poly(vinyl alcohol), a poly(vinyl acetate) or a latex polymer such as, for example, a styrene acrylic latex or styrene butadiene latex or any other binder known to the skilled person to be suitable for the purpose. The amount of binder with respect to the colloidal particle can depend on the morphology of particles and the porosity of the structure. For example, in the case of spherical particles, the volume ratio of binder-to-particle could generally range from 0 to about 0.8, more preferably from 0 to about 0.6 and most preferably from 0 to about 0.4. The level of binder required may be expected to increase with particle asymmetry or with reduction of particle size.

The support for the inkjet recording element used in the invention may be any of those usually used for inkjet receivers, such as resin-coated paper, paper, polyesters, or microporous materials such as polyethylene polymer-containing material sold by PPG Industries, Inc., Pittsburgh, Pa. under the trade name of TESLIN™, TYVEK™ synthetic paper (DuPont Corp.), and OPPalyte™ films (Mobil Chemical Co.) and other composite films listed in U.S. Patent No. 5,244,861. Opaque supports include plain paper, coated paper, synthetic paper, photographic paper support, melt-extrusion-coated paper, and laminated paper, such as biaxially oriented support laminates. Biaxially oriented support laminates are described in U.S. Pat. Nos. 5,853,965; 5,866,282; 5,874,205; 5,888,643; 5,888,681; 5,888,683 and 5,888,714, the disclosures of which are hereby incorporated by reference. These biaxially oriented supports include a paper base and a biaxially oriented polyolefin sheet, typically polypropylene, laminated to one or both sides of the paper base. Transparent supports include glass, cellulose derivatives, e.g., a cellulose ester, cellulose triacetate, cellulose diacetate, cellulose acetate propionate, cellulose acetate butyrate; polyesters, such as poly(ethylene terephthalate), poly(ethylene naphthalate), poly(1,4-cyclohexanedimethylene terephthalate), poly(butylene terephthalate), and copolymers thereof; polyimides; polyamides; polycarbonates; polystyrene; polyolefins, such as polyethylene or polypropylene; polysulfones; polyacrylates; polyetherimides; and mixtures thereof. The papers listed above include a broad range of papers, from high end papers, such as photographic paper to low end papers, such as newsprint. Additional substrates such as, for example, textiles, wood, metal or plastic may be appropriate, depending upon the proposed application.

In a preferred embodiment, the substrate or support for use in the invention is paper, resin-coated paper or a transparent support. It may have a thickness of from about 50 to about 500 μm preferably from about 75 to 300 μm. Antioxidants, antistatic agents, plasticizers and other known additives may be incorporated into the support, if desired.

In order to improve the adhesion of the ink-receiving layer to the support, the surface of the support may be subjected to a corona-discharge treatment prior to applying the image-receiving layer or layers. Alternatively an under-coating or subbing layer, such as a layer formed from a halogenated phenol or a partially hydrolysed vinyl chloride-vinyl acetate polymer, can be applied to the surface of the support.

Coating compositions employed in the invention may be applied to one or both of the substrate surfaces through pre-metered or post-metered coating methods. These methods may include dip-coating, wound-wire rod coating, grooved rod coating, smooth rod coating, air knife coating, bent or bevelled blade coating, gravure coating, forward roll coating, reverse roll coating, multiple roll coating, slide coating, bead coating, extrusion coating and curtain coating. In those cases where the coating method permits simultaneous application of multiple layers to a substrate, the colloidal particles and associated polymers for use in the invention may be applied as one or more of those layers. Known coating and drying methods are described in further detail in Research Disclosure No. 308119, published December 1989, pages 1007 to 1008. The coating composition can be coated either from water, water-based mixtures or organic solvents but water is preferred.

The choice of coating process would be determined from the economics of the operation and, in turn, would determine the formulation specifications such as coating solids, coating viscosity and coating speed.

In a preferred embodiment the coating formulation would have a coating of colloidal particles of at least 2% by volume of the coating composition: A more preferred coating composition would contain particles at a concentration of at least 4% by volume and a most preferred composition would contain at least 10% by volume colloidal particles. After application to the substrate, the coating fluids are generally dried by simple evaporation, which may be accelerated by known techniques such as convection heating. Further treatment, such as calendaring, may be used to apply a surface texture.

In order to impart mechanical durability to an inkjet recording element, crosslinkers which act upon the colloidal particles and associated polymers, or binder, if present, may be added in small quantities. Such an additive improves the cohesive strength of the layer. Crosslinkers such as vinyl sulfones, carbodiimides, polyfunctional aziridines, aldehydes, isocyanates, borax, epoxides and polyvalent metal cations may all be used.

To reduce colorant fade, UV absorbers, radical quenchers or antioxidants may also be added to the image-receiving layer as is well known in the art. Other additives include inorganic or organic particles, pH modifiers, adhesion promoters, rheology modifiers, surfactants, biocides, lubricants, dyes, optical brighteners, matte agents and antistatic agents. In order to obtain adequate coatability, additives known to those familiar with such art, such as surfactants, defoamers and alcohol, may be used. A common level for coating aids is 0.01 to 0.30% active coating aid based on the total solution volume. These coating aids can be non-ionic, anionic, cationic or amphoteric. Specific elements are described in McCutcheon's Volume 1: Emulsifiers and Detergents, 1995, North American Edition.

The image-receiving layer(s) employed in the invention can contain one or more mordanting species or polymers. However an advantage of the present invention is that it is not necessary to include a mordant to obtain the benefits of the invention. If present, the mordant polymer can be non-ionic, cationic or anionic, a soluble polymer, a charged molecule or a crosslinked dispersed microparticle. Examples of suitable mordants can be found, for example, in U.S. Pat. No. 5,474,843.

Ink jet inks used to image the recording elements of the present invention are well-known in the art. The ink compositions used in inkjet printing typically are liquid compositions comprising a solvent or carrier liquid, dyes or pigments, humectants, organic solvents, detergents, thickeners and preservatives.

The solvent or carrier liquid can be solely water or can be water mixed with other water-miscible solvents, such as polyhydric alcohols. Inks in which organic materials such as polyhydric alcohols are the predominant carrier or solvent liquid may also be used. Particularly useful are mixed solvents of water and polyhydric alcohols. The dyes used in such compositions are typically water-soluble direct or acid type dyes. Such liquid compositions have been described extensively in the prior art including, for example, U.S. Pat. Nos. 4,381,946; 4,239,543 and 4,781,758, the disclosures of which are hereby incorporated by reference.

Although the recording elements disclosed herein have been referred to primarily as being useful for inkjet printers, they also can be used as recording elements for pen plotter assemblies. Pen plotters operate by writing directly on the surface of a recording element using a pen consisting of a bundle of capillary tubes in contact with an ink reservoir. The image-receiving layers may be coated onto a wide range of substrates which can receive an image by a variety of methods.

The invention will now be described with reference to the following examples which in no way should be interpreted as restricting the scope thereof

### EXAMPLE 1

Schematic Representation of the Formation of PEMs on Colloidal Particles

The following are schematic representations of some ways in which it is envisaged that the sequential association to a colloidal particle of polyelectrolytes may occur, leading to sequential charge reversals and build-up of a multilayer. The diagrams are included to assist in understanding the invention, without being bound by theory of the actual mechanisms that may be involved. It will also be understood that in addition to sequential association, for example as represented herein, the polyelectrolytes may alternatively be added as a mixture and not sequentially.

[image]

In these diagrams, the polyelectrolytes contain ionised or ionisable groups. Although the polyelectrolytes are drawn as highly charged, it may be possible that under the pH conditions of mixing the polymers are essentially uncharged. The addition of a third polyelectrolyte may cause charge reversal of the particle/polymer composite (as shown in the schematic), or it is possible to add a small amount of the third polyelectrolyte, in which case charge reduction rather than reversal may occur. In diagram (C) the particle can be positively or negatively charged. The polyampholyte can be of the same or opposite net charge to the particle. Polyelectrolyte 1 must contain ionised or ionisable groups, which can be of the same or opposite charge to the colloidal particle. Polyelectrolyte 2 must contain ionised or ionisable groups, which must be of opposite charge to polyelectrolyte 1.

### EXAMPLE 2

Coating of Particles

(a) Method

The coating formulations were made according to the experimental procedures described below. The formulations described all contained 15% w/w silica, corresponding to a volume fraction of 7.43%. Hand coatings were made from these formulations, with a blade set with a gap of 150 μm onto a 100 μm thick polyethylene terephthalate film with a 50 mg.m⁻² dry gelatin ‘subbing’ layer. The film was held on a stainless steel platen by vacuum. Unless indicated the platen was maintained at 30 C by circulating water. The coatings were dried on the platen at this temperature, taking up to 45 min. to dry.

Where indicated, stirring was carried out using a magnetic stirrer bar. Filtration was carried out by transferring the sample into a syringe and passing through a 26 mm diameter cellulose acetate filter (Sartorius MINIART™) with pores of 5 μm diameter.

Each example relied on mixing colloidal suspensions and polymer solutions. The volume ratio (referred to hereafter as Vr) of the two liquids is expressed as
Volume of colloid suspension/Volume of polymer solution.

Unless otherwise stated the colloidal suspensions and polymer solutions were ‘syringe mixed’. The liquids were taken into graduated syringes, which were then connected to a 90° T-piece junction of internal diameter 1.6 mm T-piece via flexible tubing. The liquid was displaced through the T-piece at a rate of approximately 5 ml.s⁻¹. Occasionally it was not possible to syringe mix the solutions in which case, the solutions were ‘addition mixed’. In this procedure a known volume of colloidal suspension was added to a known volume of polymer solutions whilst stirring. The methods indicate where addition mixing was used.

(b) Materials

Materials were used as supplied unless otherwise stated and as indicated in Table 1. All solutions were made in deionised water. All concentrations are expressed as w/w %.

TABLE 1

| | | Trade | |
|---|---|---|---|
| Description | Supplier | name | Other comments |
| Cationic colloidal silica, | Ondeo | | Particle diameter |
| (aluminised surface) | Nalco | | 77 nm* |
| Anionic colloidal silica | Grace | LUDOX ™ | Particle diameter |
| | Davison | PW50 | 77 nm† |
| Polyethyleneimine (PEI) | Aldrich | | 2 kD mean Mw* |
| Polyethyleneimine (PEI) | Aldrich | | 750 kD mean |
| | | | Mw* |
| Sodium poly(styrene | Alco | VERSA ™ | 200 kD |
| sulfonate) (PSS) | Chemical | TL130 | mean Mw* |
| Copolymer of sodium | Alco | NARLEX ™ | 15 kD |
| styrene sulfonate and | Chemical | D 72 | mean Mw* |
| maleic anhydride | | | |
| Copolymer of sodium | Alco | VERSA ™ | 20 kD Mw* |
| styrene sulfonate and | Chemical | TL 3 | |
| maleic anhydride | | | |
| Poly(4-vinylpyridine | Aldrich | | 60 kD Mw* |
| (P4VP) | | | |
| Anionically derivatised | Nippon | Gohseran | Low degree of |
| poly(vinylalcohol) (APVA) | Gohsei | L-0302 | saponification and |
| | | | sulfonic acid |
| | | | modified*. |
| Cationically derivatised | Nippon | Gohsefimer | |
| poly(vinylalcohol) (CPVA) | Gohsei | K-210 | |
| Low gel strength, de- | Eastman | | |
| calcified lime processed | Gelatin | | |
| ossein gelatin | | | |
| Polyacrylic acid (PAA) | Aldrich | | 2 kD |

*According to manufacturer's data
†Measured using photon correlation spectroscopy

(c) Comparison Commercial Samples

Two commercially available materials were tested as supplied.

(i) Porous Receiver

Epson Premium Glossy Photo Paper P-1.

This is a rapid-drying porous inkjet receiver with high gloss but poor ozone stability.

(ii) Swellable Receiver

High Gloss Kodak Premium Picture Paper S-1.

This is a polymeric receiver which absorbs ink slowly but has very high gloss and provides images with excellent stability to ozone.

### EXAMPLE 3

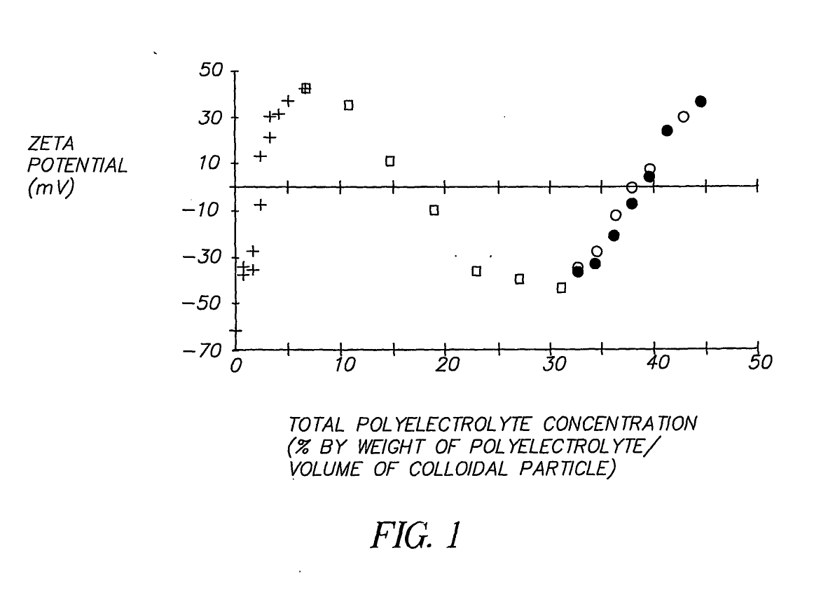

Analysis of FIG. 1

In the experiments on which FIG. 1 is based the anionic silica used was LUDOX™ PW50 of particle diameter 77 nm. All materials are fully described in the Table above. In FIG. 1 and the following discussion the amount of polymer present is expressed as percentage weight of polymer per volume of particle. This is a useful measure as it is independent of the final particle concentration.

The zeta potential of a particle is a measure of the effective surface charge of the particle at the hydrodynamic slipping plane. The zeta potential may be determined from a particle's electrophoretic mobility. Here, the zeta potential was measured with a Malvern Zetasizer 3000HS instrument. For these measurements, the parent suspensions were diluted to 0.0500 v/v % (in the absence of polyelectrolyte) or 0.01250 v/v % (in the presence of polyelectrolyte) silica to avoid multiple scattering. All zeta potential measurements were made with solutions at 0.01 M NaCl at 25° C. at pH 6.

The cationic polyelectrolyte 2 kD PEI was added at different levels to the anionic silica particles (+). A gradual reversal of the zeta potential from negative to positive values with increasing PEI concentration was apparent. Next, different levels of the anionic polyelectrolyte, 200 kD PSS were added to the suspensions of 6.75% 2 kD PBI on silica (□). The zeta potential of these PEI-silica particles was reduced from positive to negative in the presence of increasing amounts of 200 kD PSS.

Then, to suspensions of silica with successively added 6.75% 2 kD PEI and 24.3% 200 kD PSS (the total polyelectrolyte concentration was 31.1%) a second cationic polyelectrolyte (750 kD PEI) was added (●). Addition of the PEI, once again reversed the sign of the zeta potential of the particles.

The final data shown describe an experiment in which solutions of the 200 kD PSS anionic polyelectrolyte with different concentrations of the 750 kD PEI cationic polyelectrolyte were added to suspensions of silica with 6.75% 2 kD PEI. The concentrations of the pre-mixed solutions were determined so that the final compositions consisted of 6.75% 2 kD PEI and 24.3% 200 kD PSS with varying amounts of 750 kD PEI on LUDOX™ PW50. These compositions are equivalent to those described in the previous paragraph. The zeta potentials of the particles prepared with the pre-mixed PSS/750 kD PEI solutions (◯) were identical (within experimental error) to those where each polyelectrolyte had been added in a separate stage (●).

### EXAMPLE 4

To Investigate ‘Dry Time’ of Prints

(a) Compositions

### COMPARATIVE EXAMPLES

P-1 Epson Premium Glossy Photo Paper.

S-1 High Gloss Kodak Premium Picture Paper.

C-1 LUDOX™ PW50, 2 kD PEI

A suspension of 48.18% PW50 was mixed (Vr=1) with a solution of 1.49% 2 kD PEI to give a uniform, fluid suspension of 27.73% PW50 and 0.86% 2 kD PEI. After 30 min. this suspension was mixed (Vr=1) with deionised water to give a uniform, low-viscosity fluid. The final composition of the suspension was 15% PW50 and 0.46% 2 kD PEI. The sample was held with stirring for 120 min., filtered and stirred for a further 30 min. before coating.

C-2 LUDOX™ PW50, 200 kD PSS

A suspension of 27.73% PW50 was mixed (Vr=1) with a solution of 3.62% 200 kD PSS to give a uniform, fluid suspension of 15% PW50 with 1.66% 200 kD PSS. The resultant suspension was held with stirring for 150 min. then coated.

C-3 LUDOX™ PW50, Gelatin

A suspension of 27.73% PW50 at was mixed (Vr=1) with a solution of 1.17% gelatin to give a uniform, fluid suspension of 15% PW50 with 0.538% gelatin. The resultant suspension was held with stirring for 30 rmin. before coating.

C-4 LUDOX™ PW50, 60kD P4VP

A solution of 3.50% 60 kD P4VP was prepared in 0.3M hydrochloric acid. This solution was mixed (Vr=2.79) with a suspension of 19.80% PW50 to give a uniform, fluid suspension of 15% PW50 with 0.85% 60 kD P4VP. The resultant suspension was held with stiring for 55 min., filtered and stirred for a further 5 min. before coating.

C-5 LUDOX™ PW50, Gohsefimer K210 (CPVA)

A suspension of 27.73% PW50 was mixed (Vr=1) with a solution of 2.18% CPVA to give a unifoim fluid suspension of 15% PW50 with 1% CPVA. The resultant suspension was immediately coated.

C-6 Cationic Silica, 200 kD PSS

A suspension of 27.73% cationic silica was mixed (V=1) with a solution of 3.27% 200 kD PSS to give a uniform, fluid suspension of 15% cationic silica with 1.5% 200 kD PSS. The resultant suspension was held with stirring for 30 miin. before coating. The suspension was coated onto and dried on a platen held at 45 C.

C-7 Cationic Silica, NARLEX™ 15 kD D72

A suspension of 27.73% cationic silica was mixed (Vr=1) with a solution of 3.27% 15 kD D72 to give a uniform, fluid suspension of 15% cationic silica with 1.5% 15 kD D72 The resultant suspension was held with stirring for 30 min. before coating. The suspension was coated onto and dried on a platen held at 45 C.

### INVENTIVE EXAMPLES

I-1 LUDOX™ PW50, 2 kD PEI, 200 kD PSS, 750 kD PEI

A suspension of 50% LUDOX™ PW50 was mixed (Vr=1.327) with a solution of 2.82% 2 kD PEI to give a uniform, fluid suspension of 32.3% PW50 with 1.00% 2 kD PEI. The resultant suspension was held with stirring for 30 min. then mixed (Vr=1) with a solution of 4.35% 200 kD PSS to give a suspension of composition 17.71% PW50, 0.55% 2 kD PEI and 1.96% 200 kD PSS. This suspension was held with sting for 60 min., filtered and then addition mixed (Vr=5) with 0.76% 750 kD PEI to give a final composition of 15% PW50, 0.46% 2 kD PEL 1.66% 200 kDPSS and 0.12% 750 kD PEI. This suspension was filtered, then held with stirring for lh before coating.

I-2 LUDOX™ PW50 pre-mixed Gohsefimer K-210 (CPVA) and 200 kD PSS

A suspension of 27.73% PW50 was mixed (Vr=1) with a pre-mixed solution of 0.65% CPVA and 2.42% 200 kD PSS to give a uniform, fluid suspension of 15% PW50 with 0.3% CPVA and 1.11% 200 kD PSS. The resultant suspension was held for 1 day with intermittent stirring before being coated.

I-3 LUDOX™ PW50, 2 kD PEI Gohseran L-0302 (APVA)

A suspension of 50% PW50 was mixed (Vr=0.9055) with a solution of 1.92% 2 kD PEI to give a uniform, fluid suspension of 27.73% PW50 with 0.86% 2 kD PEI. The resultant suspension was held with stirring for 30 min. then mixed (Vr=1) with a solution of 3.27% APVA to give a suspension of composition 15% PW50, 0.463% 2 kD PEI and 1.5% APVA. This suspension was held with stirring for 30 min. before coating.

I-4 LUDOX™ PW50 Gelatin, pre-mixed 200 KD PSS and 750 KD PEI

A suspension of 50% PW50 at was mixed (Vr=0.9055) with a solution of 4.47% gelatin to give a uniform, fluid suspension of 27.73% PW50 with 1.99% gelatin. The resultant suspension was held with stirring for 30 min. then mixed (Vr=1) with a solution of pre-mixed 3.62% 200 kD PSS and 0.25% 750 kD PEI to give a suspension of composition 15% PW50, 1.077% gelatin, 1.66% 200 kD PSS and 0.12% 750 kD PEI. This suspension was stirred and coated immediately.

I-5 LUDOX™ PW50, 2 kD PEI VERSA™ 2 kD TL3

A suspension of 50% PW50 was mixed (Vr=0.9055) with a solution of 1.92% 2 kD PEI to give a uniform, fluid suspension of 27.73% PW50 with 0.86% 2 kD PEI. The resultant suspension was held with stirring for 30 min. then mixed (Vr=1) with a solution of 3.19% 20 kD TL3 to give a suspension of composition 15% PW50, 0.463% 2 kD PEI and 1.47% 20 kD TL3. This suspension was held with stirring for 100 min., filtered then stirred 20 min. before coating.

I-6 LUDOX™ PW50 2 kD PEI, NARLEX™ 15 kD D72

A suspension of 50% PW50 was mixed (Vr=0.9055) with a solution of 1.92% 2 kD PEI to give a uniform, fluid suspension of 27.73% PW50 with 0.86% 2 kD PEI. The resultant suspension was held with stirring for 30 min. then mixed (Vr=1) with a solution of 2.76% 15 kD D72 to give a suspension of composition 15% PW50, 0.463% 2 kD PEI and 1.265% 15 kD D72. The suspension was held with stirring for 30 min. before coating.

I-7 LUDOX™ PW50, 2 kD PEI, 2 kD PAA

A suspension of 50% PW50 was mixed (Vr=0.9055) with a solution of 1.92% 2 kD PEI to give a uniform, fluid suspension of 27.73% PW50 with 0.86% 2 kD PEI. The resultant suspension was held with stirring for 25 min. then mixed (Vr=1) with a solution of 1.27% 2 kD PAA to give a suspension of composition 15% PW50, 0.463% 2 kD PEI and 0.581% 2 kD PAA. This suspension was held with stirring for 25 min. and then coated.

I-8 Cationic Silica, NARLEX™ 15 kD D72, 2 kD PEI

A suspension of 28% cationic silica was mixed (Vr=2.25) with a solution of 7.31% 15 kD D72 to give a uniform, fluid suspension of 20.33% cationic silica with 2.00% 15 kD D72. The resultant suspension was held with stirring for 30 min. then mixed (Vr=2.5) with a solution of 1.31% 2 kD PEI to give a suspension of composition 15% cationic silica, 1.478% 15 kD D72 and 0.343% 2 kD PEI. This suspension was held with stirring for 30 min. and then coated.

I-9 Cationic Silica, VERSA™ 20 kD TL3, 2 kD PEI

A suspension of 28% cationic silica was mixed (Vr=2.25) with a solution of 7.31% 20 kD TL3 to give a uniform, fluid suspension of 20.33% cationic silica with 2.00% TL3. The resultant suspension was held with stirring for 30 min. then mixed (Vr=2.5) with a solution of 1.31% 2 kD PEI to give a suspension of composition 15% cationic silica, 1.478% 20 kD TL3 and 0.343% 2 kD PEI. This suspension was held with stirring for 30 min. and then coated.

(b) The Ink Transfer Test

The ink transfer test is designed to assess the dry time of the printed image. A low value of ink transfers would imply a quick dry time. Images were printed with an HP Deskjet 970C inkjet printer with the corresponding HP ink set. The test pattern contained three different densities of the colours yellow, magenta, cyan, red, green, blue and black and a series of black lines and symbols of different size. The speed of drying was assessed by assessing the image density transferred to a piece of plain paper that had been pressed manually onto the image immediately post printing. A low ink transfer, indicating quick dry-time, is desirable.

(c) Ink Transfer Results

Ink transfer was graded on a scale of 1 to 5. 1=No ink transfer, 2=very low ink transfer, 3=low ink transfer, 4=medium ink transfer, 5=high ink transfer.

TABLE 2

| Example | Ink Transfer |
|---|---|
| P-1 | 1 |
| S-1 | 5 |
| C-1 | 1 |
| C-2 | 1 |
| C-3 | 5 |
| C-4 | 3 |
| C-5 | 5 |
| C-6 | 3 |
| C-7 | 2 |
| I-1 | 3 |
| I-2 | 2 |
| I-3 | 2 |
| I-4 | 1 |
| I-5 | 2 |
| I-6 | 1 |
| I-7 | 1 |
| I-8 | 2 |
| I-9 | 2 |

The data in Table 2 shows the ink transfer performance of the coatings wherein it can be seen that the commercial porous receiver P-1 shows quick ink, uptake, whilst the commercial swellable receiver S-1 has a long drytime, The other comparative examples show behaviour ranging from no ink transfer to very high ink transfer. The coatings illustrative of the invention all show low ink transfer or better (rankings of 3 or less).

### EXAMPLE 5

To Investigate Gloss of Coatings

(a) Compositions

### COMPARATIVE EXAMPLES

P-1, S-1 and C-1 to C7 as in Example 3

### INVENTIVE EXAMPLES

I-1 to I-3 as in Example 3

I-10 LUDOX™ PW50, pre-mixed 2 kD PEI and NARLEX™ 15 kD D72

A suspension of 27.73% PW50 was mixed (Vr=1) with a pre-mixed solution of 2.76% 15 kD D72 and 1.01% 2 kD PEI to give a uniform, fluid suspension of 15% PW50 with1.27% 15 kD D72, and 0.46% 2 kD PEI. The resultant suspension was held with stirring for 87 min., filtered and then stirred 10 min. before coating.

I-11 Cationic Silica, 2 kD PAA, 2 kD PEI

A suspension of 28% cationic silica was mixed (Vr=2.25) with a solution of 3.98% 2 kD PAA to give a uniform, fluid suspension of 20.33% cationic silica with 1.09% 2 kD PAA. The resultant suspension was held with stirring for 30 min. then mixed (Vr=2.5) with a solution of 1.31% 2 kD PEI to give a suspension of composition 15% cationic silica, 0.803% 2 kD PAA and 0.343% 2 kD PEI. This suspension was held with stirring for 30 min. and then coated.

I-12 Cationic Silica, 200 kD PSS, 750 kD PEI

A suspension of 28% cationic silica was mixed (Vr=2.25) with a solution of 7.31% 200 kD PSS to give a uniform, fluid suspension of 20.33% cationic silica with 2.00% 200 kD PSS. The resultant suspension was held with stirring for 30 min. then mixed (Vr=2.5) with a solution of 1.31% 750 kD PEI to give a suspension of composition 15% cationic silica, 1.478% 200 kD PSS and 0.343% 750 kD PEI. This suspension was held with stirring for 30 min. and then coated.

(b) Gloss Test

The gloss of the coating was measured using a ‘Tri-microgloss Meter’ (Sheen Instruments Ltd, UK) and the value at 60° used for comparison. Commercial receivers may have different levels of gloss depending upon their intended use.

(c) Gloss Results

The gloss was rated on a 1-5 scale. 5=matte (gloss=0-10%), 4=satin (gloss=10-25%), 3=soft gloss (gloss=25-40%), 2=glossy (gloss=40-55%), 1=super glossy (gloss>55%).

TABLE 3

| Example | Gloss at 60° |
|---|---|
| P-1 | 3 |
| S-1 | 1 |
| C-1 | 1 |
| C-2 | 5 |
| C-3 | 1 |
| C-4 | 1 |
| C-5 | 4 |
| C-6 | 4 |
| C-7 | 4 |
| I-1 | 3 |
| I-2 | 2 |
| I-3 | 1 |
| I-10 | 2 |
| I-11 | 4 |
| I-12 | 5 |

Usefully, the gloss of the enabling embodiments can vary between any of the 5 categories.

### EXAMPLE 6

To Investigate Ozone Fade and Density of Printed Images

(a) Compositions

### COMPARATIVE EXAMPLES

P-1, S-1 and C-1 to C7 as in Example 4

### INVENTIVE EXAMPLES

I-1 to I-4 as in Example 4

I-13 LUDOX™ PW50, 2 kD PEI, premixed 200 kD PSS, 750 kD PEI

A suspension of 48.18% PW50 was mixed (Vr=1) with a solution of 1.49% 2 kD PEI to give a uniform, fluid suspension of 27.73% PW50 and 0.86% PEI. The resultant suspension was held with stirring for 30 min. then mixed (Vr=1) with a pre-mixed solution of 3.62% 200 kD PSS and 0.21% 750 kD PEI. The final composition was 15% PW50, 0.46% 2 kD PEI, 1.66% 200 kD PSS, and 0.12% 750 kD PEI. This sample was held with stirring for 120 min., filtered, and stirred for a furer 30 min. before coating.

I-14 LUDOX™ PW50, 2 kD PEl, 200 kD PSS

A suspension of 48.18% PW50 was mixed (Vr=1) with a solution of 1.49% 2 kD PEI to give a uniform, fluid suspension of 27.73% PW50 and 0.86% 2 kD PEI. The resultant suspension was held with stirring for 30 min. then mixed (Vr=1) with a solution of 3.62% 200 kD PSS. The final composition was 15% PW50, 0.46% 2 kD PEI and 1.66% 200 kD PSS. This sample was held with stirring for 120 min., filtered and stirred for a fuirther 30 minutes before coating.

I-15 LUDOX™ PW50, Gelatin, 2 kD PEI

A suspension of 48.18% PW50 at was mixed (Vr=1) with a solution of 2.34% gelatin to give a uniform, fluid suspension of 27.73% PW50 with 1.00% gelatin. The resultant suspension was held with stirring for 30 min. then mixed (Vr=1) with a solution of 0.88% 2 kD PEI to give a suspension of composition 15% PW50, 0.538% gelatin, and 0.405% 2 kD PEI. This suspension was held with stirring for 30 min. before coating.

I-16 LUDOX™ PW50, pre-mixed 2 kD PEI and 200 kD PSS

A suspension of 27.73% PW50 was mixed (Vr=1) with a pre-mixed solution of 3.62% 200 kD PSS and 1.01% 2 kD PEI to give a uniform, fluid suspension of 15% PW50 with 1.66% 200 kD PSS and 0.46% 2 kD PEI. The resultant suspension was held with stirring for 110 min., filtered, then stirred for a further 4 min. before coating.

I-17 LUDOX™ PW50, 60 kD P4VP and 200 kD PSS

A solution of 3.52% 60 kD P4VP was prepared in 0.3M HCl. This solution was mixed (Vr=0.906) with a suspension of 50% PW50 to give a uniform, fluid suspension of 27.73% PW50 with 1.57% 60 kD P4VP. The resultant suspension was held with stirring for 30 min. then mixed (Vr=1) with a solution of 3.62% 200 kD PSS to give a suspension of composition 15% PW50, 0.848% 60 kD P4VP and 1.663% 200 kD PSS. This suspension was held with stirring for 30 min. before coating.

(b) Assessment of Initial Image Density and Image Stability to Ozone

To assess image stability to ozone, cyan, magenta and yellow patches were printed with a Kodak Personal Picture Maker 200 inkjet printer and corresponding Kodak ink-set. The images were allowed to dry overnight then the initial colour densities measured. The status A print densities were measured with a X-rite™ 310 Colour Transmission/Reflection Densitometer (X-rite company) The printed images were placed in an environment with a high level of ambient ozone (approximately 5 ppm). The loss in image density after 24 h was assessed by re-measuring the status A print densities. A sample of comparative sample papers S-1 and P-1 was always present alongside the experimental samples for comparison to allow for any variation in ozone levels. A high initial image density and a low loss in density on exposure to ozone is desirable.

(c) Image Stability to Ozone Results The fade was rated on a 1-5 scale. 1=very low or no fade, 2=low fade, 3=medium fade, 4=high fade, 5=very high fade. The yellow fade was always very low or less. The initial ink density is the measured status A density.

TABLE 4

| | Fade after | | | | |
|---|---|---|---|---|---|
| | exposure to ozone | | | | |
| | Cyan | | Initial ink density | | |
| Example | ink | Magenta ink | Cyan ink | Magenta ink | Yellow ink |
| P-1 | 4 | 4 | 0.600 | 0.920 | 1.060 |
| S-1 | 1 | 1 | 0.744 | 0.865 | 0.942 |
| C-1 | 5 | 3 | 0.663 | 1.117 | 1.200 |
| C-2 | 4 | 3 | 0.843 | 1.087 | 1.322 |
| C-3 | 5 | 5 | 0.810 | 1.170 | 1.330 |
| C-4 | 3 | 5 | 0.687 | 1.111 | 1.613 |
| C-5 | 5 | 4 | 0.639 | 1.064 | 1.252 |
| C-6 | 5 | 5 | 0.966 | 1.239 | 1.462 |
| C-7 | 5 | 5 | 0.958 | 1.188 | 1.295 |
| I-1 | 2 | 1 | 0.772 | 1.210 | 1.340 |
| I-2 | 3 | 2 | 0.891 | 1.166 | 1.441 |
| I-3 | 3 | 2 | 0.862 | 1.097 | 1.351 |
| I-4 | 2 | 2 | 0.893 | 1.257 | 1.628 |
| 1-13 | 2 | 2 | 0.814 | 1.236 | 1.415 |
| 1-14 | 1 | 1 | 0.708 | 1.184 | 1.366 |
| 1-15 | 2 | 3 | 0.890 | 1.190 | 1.280 |
| 1-16 | 2 | 1 | 0.875 | 1.226 | 1.467 |
| 1-17 | 3 | 3 | 0.815 | 1.102 | 1.208 |

The commercial receiver S-1 showed excellent resistance to ozone fade; however, the porous commercial receiver P-1 was not effective at preventing ozone fade. The other comparative examples all show high fade levels. The enabling embodiments all gave significantly better fade resistance than P-1, with some samples giving comparable performance to S-1.

In addition to the ozone behaviour, the initial print densities of the enabling embodiments are advantageously higher than that of the commercial receivers and of the same order as those of the other comparative receivers. The coating I-14 has a slightly lower initial cyan density, but significantly higher magenta and yellow densities than the commercial receivers and comparable densities to the comparative examples.

(d) Combination of Fast Dry Time and Ozone Fade Resistance

Ink transfer was graded on a scale of 1 to 5. 1=No ink transfer, 2=very low ink transfer, 3=low ink transfer, 4=medium ink transfer, 5=high ink transfer. Low ink transfer is desirable.

The fade was rated on a 1-5 scale. 1=very low or no fade, 2=low fade, 3=medium fade, 4=high fade, 5=very high fade. The yellow fade was always very low or less. Low ozone fade is desirable.

TABLE 5

| Example | Ink Transfer | Cyan fade | Magenta fade |
|---|---|---|---|
| P-1 | 1 | 4 | 4 |
| S-1 | 5 | 1 | 1 |
| C-1 | 1 | 5 | 3 |
| C-2 | 1 | 4 | 3 |
| C-3 | 5 | 5 | 5 |
| C-4 | 3 | 3 | 5 |
| C-5 | 5 | 5 | 4 |
| C-6 | 3 | 5 | 5 |
| C-7 | 2 | 5 | 5 |
| I-1 | 3 | 2 | 1 |
| I-2 | 2 | 3 | 2 |
| I-3 | 2 | 3 | 2 |

The porous commercial receiver P-1 shows short dry times with poor resistance to ozone fade. Conversely, the swellable commercial receiver S-1 shows long dry times with good resistance to ozone fade. The elements for use in the invention I-1 to I-3 show an advantageous combination of shorter drytimes than the commercial swellable receiver S-1 with less ozone fade than the commercial porous receiver P-1. The comparative examples C-1 to C-7 do not show this combination of properties. In addition, it is shown in examples 5 and 6 that enabling embodiments have a higher initial ink density than the commercial materials, and can be made with any level of gloss.

### EXAMPLE 7

To Investigate Ozone Fade of Printed Images with the Epson Ink Set

In These Examples the Silica used was LUDOX™ PW50, Particle Diameter 65 nm

(a) Compositions

### COMPARATIVE EXAMPLES

P-1, S-1 as in Example 4

C-8. LUDOX™ PW50, 2 kD PEI

A suspension of 27.7% PW50 was mixed (Vr=1) with a solution of 1.20% 2 kD PEI to give a uniform, fluid suspension of 15.0% PW50 and 0.55% 2 kD PEI. The resultant suspension was held with stirring for 180 min., before coating.

### INVENTIVE EXAMPLES

I-18 LUDOX™ PW50, 2 kD PEI 200 kD PSS, 2 kD PEI

A suspension of 27.7% PW50 was mixed (Vr=1) with a solution of 1.20% 2 kD PEI to give a uniform, fluid suspension of 15.0% PW50 and 0.55% 2 kD PEI. The resultant suspension was held with stirring for 1 h then addition mixed (Vr=11.49) with 29.92% 200 kD PSS to give a uniform fluid suspension of composition 13.89% PW50, 0.51% 2 kD PEI and 2.21% 200 kD PSS. The resultant suspension was held with stirring for 1 h then addition mixed (Vr=31.17) with 25.35% 2 kD PEI to give a final composition of 13.49% PW50, 0.49% 2 kD PEI 2.15%200 kD PSS and 0.73% 2 kD PEI.

(b) Assessment of Initial Image Stability to Ozone Using an Epson Printer.

To assess image stability to ozone, cyan, magenta and yellow patches were printed with an Epson Stylus Photo 870 inkjet printer and corresponding Epson ink-set. The images were allowed to dry then the initial colour densities measured. The status A print densities were measured with an X-rite™ 310 Colour Transmission/Reflection Densitometer (X-rite company). The printed images were placed in an environment with a high level of ambient ozone (approximately 5 ppm). The loss in image density after 24 h was assessed by re-measuring the status A print densities. A sample of comparative sample papers S-1 and P-1 was always present alongside the experimental samples for comparison to allow for any variation in ozone levels. A low loss in density on exposure to ozone is desirable.

(c) Image Stability to Ozone Results

The fade was rated on a 1-5 scale. 1=very low or no fade, 2=low fade, 3=medium fade, 4=high fade, 5=very high fade. The yellow fade was always very low or less.

TABLE 6

Fade after exposure to
ozone

| Example | Cyan ink | Magenta ink |
|---|---|---|
| P-1 | 4 | 5 |
| S-1 | 1 | 2 |
| C-8 | 1 | 4 |
| I-18 | 1 | 1 |

The commercial receiver S-1 showed excellent resistance to ozone fade; however, the porous commercial receiver P-1 was not effective at preventing ozone fade. The other comparative example performed relatively well with this ink set, exceeding the performance of P-1. However, the embodiment for use in the invention gave better fade resistance than both P-1 and S-1. This example illustrates that the benefits of the invention are not limited to a single ink set.

The invention has been described in detail with particular reference to preferred embodiments thereof, but it will be understood that variations and modifications can be effected within the scope and spirit of the invention.

According to the present invention there is provided an inkjet recording element comprising a support having thereon at least one image-receiving layer, said inkjet recording element containing colloidal particles having a charged or chargeable surface and having associated therewith at least two water-soluble polymers having ionised or ionisable groups thereon, wherein one of those polymers has ionised or ionisable groups of opposite charge to that of the surface of the colloidal particles and another of those polymers has ionised or ionisable groups the same as that of the surface of the colloidal particles.

Please replace the paragraph beginning on page 4, line 6 with the following rewritten paragraph:

(b) combining the colloidal particles with at least two water-soluble polymers having ionised or ionisable groups thereon, one of those polymers having ionised or ionisable groups of opposite charge to that of the surface of the colloidal particles and another of those polymers having ionised or ionisable groups the same as that of the surface of the colloidal particles, to provide a coatable formulation;

Please replace the paragraph beginning on page 7, line 23 with the following rewritten paragraph:

Polyelectrolytes, generally, are understood as polymers having charged or chargeable groups, which can be a component or substituent of the polymer chain. The number of these charged or chargeable groups in polyelectrolytes is so large that the polymers (also called polyions) are water-soluble. The terms “charged polymer”, “chargeable polymer” and the term “polyelectrolyte” are, in general, used interchangeably herein to include, without limitation any polymer or oligomer that contains charged or chargeable groups. Polymers with both anionically and cationically charged or chargeable groups are referred to as polyampholytes and these are specifically included within the term ‘polyelectrolyte’. Suitable polyelectrolytes according to the invention are also biopolymers, modified biopolymers and biopolymer derivatives.

Please replace the paragraph beginning on page 8, line 6 with the following rewritten paragraph:

In accordance with this invention at least two water-soluble polymers, preferably two or three, are associated with the colloidal particles, either sequentially and/or as a mixture. Any charged polymer can be used that has a positive charge, a negative charge or can be induced to carry a charge to provide a net positive or negative charge, for example by adjusting the solution pH.

1. An inkjet recording element comprising a support having thereon at least one image-receiving layer, said inkjet recording element containing colloidal particles having a charged or chargeable surface and having associated therewith at least two water-soluble polymers having ionised or ionisable groups thereon, wherein one of those polymers has ionised or ionisable groups of opposite charge to that of the surface of the colloidal particles and another of those polymers has ionised or ionisable groups the same as that of the surface of the colloidal particles.

2. An element as claimed in claim 1 wherein the colloidal particles are organic, inorganic or a composite thereof.

3. An element as claimed in claim 1 wherein the colloidal particles are negatively charged and are selected from the class consisting of a silica, surface-treated silica, zinc oxide, zirconium oxide, aluminium oxide, titanium oxide, barium sulfate, kaolin clay, calcined clay, montmorillonite and talc.

4. An element as claimed in claim 1 wherein the colloidal particles are positively charged and are selected from the class consisting of a silica, surface-treated silica, aluminium oxide, zinc oxide, magnesium oxide and calcium carbonate.

5. An element as claimed in claim 1 wherein the particles are colloidal silica, silica gel, hydrous silica or fumed silica.

6. An element as claimed in claim 1 wherein the equivalent spherical diameter of the colloidal particles is from about 0.01 to about 10 μm.

7. An element as claimed in claim 6 wherein the equivalent spherical diameter of the colloidal particles diameter is from about 0.04 to about 0.5 μm.

8. An element as claimed in claim 1 wherein a polymer includes a monomer that has a positive charge or can be induced to have a positive charge and is independently selected from the class consisting of allylamine, ethyleneimine, vinylamine, 2-vinylpyridine, 4-vinylpyridine, diallyldimethylammonium, 2-vinylpiperidine, 4-vinylpiperidine, 2-butyl-methacryloxyethyltrimethyl ammonium, 4-vinybenzyltrimethylammonium, N,N′-bis 2,2,6,6-tetrainethyl-4-piperidine, dimethyliminomethylene, butyl acrylate methacryloxyethyltrimethylammonium and a salt or derivative thereof.

9. An element as claimed in claim 1 wherein a polymer is selected from polyethyleneimine, poly(4-vinylpyridine) and cationically-modified polyvinyl alcohol.

10. An element as claimed in claim 1 wherein a polymer includes a monomer that has a negative charge or can be induced to have a negative charge and is independently selected from the class consisting of styrenesulfonic acid, vinylsulfonic acid, acrylic acid, 2-acrylamido-2-methyl-propane sulfonic acid, maleic anhydride, maleic acid, ethylene sulfonic acid, methacrylic acid, vinylsulfuric acid, ethylenephosphonic acid, maleic acid, 2-methacryloxyethane-1-sulfonic acid, 3-methacryloxyethane-1-sulfonic acid, vinylbenzoic acid, 3-(vinyloxy)propane-1-sulfonic acid, 4-vinylphenol, 4-vinyl-phenylsulfuric acid, 4-n-vinylsuccinamic acid and a salt or derivative thereof.

11. An element as claimed in claim 1 wherein a polymer is selected from the class consisting of a sodium polystyrene sulfonate, a polystyrene sulfonate salt, a copolymer of styrene sulfonate with another monomer, a copolymer of styrene sulfonates and a monomer of maleic acid or anhydride monomer, polyacrylic acid, poly 2-acrylamido-2-methyl-propane sulfonate and an anionically-modifed polyvinyl alcohol.

12. An element as claimed in claim 1 wherein a polymer comprises a styrenesulfonate monomer.

13. An element as claimed in claim 1 wherein a polymer is a polyampholyte copolymer comprising a mixture of uncharged and pH-dependent negative and positive charges.

14. An element as claimed in claim 13 wherein the polyampholyte is gelatin or a gelatin derivative.

15. An element as claimed in claim 1 wherein the total weight of polymer based upon volume of the colloidal particles is about 10 to about 40%.

16. An element as claimed in claim 1 wherein the ratio of a polymer or polymers of one charge type to that of another polymer or polymers of another charge type is not more than about 100:1.

17. An element as claimed in claim 1 wherein the image-receiving layer contains a binder selected from the class consisting of a poly(vinylalcohol), poly(vinyl acetate), styrene acrylic latex and styrene butadiene latex.

18. An element as claimed in claim 1 wherein the image-receiving layer contains one or more mordants.

19. A method of coating a substrate comprising the steps of
(a) providing colloidal particles having a charged or chargeable surface:
(b) combining the colloidal particles with at least two water-soluble polymers having ionised or ionisable groups thereon, one of those polymers having ionised or ionisable groups of opposite charge to that of the surface of the colloidal particles and another of those polymers having ionised or ionisable groups the same as that of the surface of the colloidal particles to provide a coatable formulation;
(c) applying the formulation to the substrate to form a coating thereon and
(d) drying the resultant coating.

20. A method as claimed in claim 19 wherein the at least two polymers are added either sequentially and/or as a mixture.

21. (canceled)

22. (canceled)

23. A method as claimed in claim 19 wherein the substrate is paper, resin-coated paper or a transparent support.

24. A method as claimed in claim 19 wherein the formulation is coated onto the substrate by a pre-metered or post-metered coating method.

25. A method as claimed in claim 19 wherein the coating formulation comprises at least 4% by volume of colloidal particles.

26. The use of colloidal particles to provide an inkjet element providing improved image stability and dry time having a charged or chargeable surface and at least two polymers having ionised or ionisable groups thereon to provide an inkjet recording element comprising a support having thereon at least one image-receiving layer, said inkjet recording element containing said colloidal particles and having associated therewith said at least two water-soluble polymers, wherein one of those polymers has ionised or ionisable groups of opposite charge to that of the surface of the colloidal particles and another of those polymers has ionised or ionisable groups the same as that of the surface of the colloidal particles.

27. An inkjet printing method comprising the steps of
(a) providing an inkjet printer that is responsive to digital data signals;
(b) loading the printer with an inkjet recording element comprising a support having thereon at least one image-receiving layer, said inkjet recording element containing colloidal particles having a charged or chargeable surface and having associated therewith at least two water-soluble polymers having ionised or ionisable groups thereon, wherein one of those polymers has ionised or ionisable groups of opposite charge to that of the surface of the colloidal particles and another of those polymers has ionised or ionisable groups the same as that of the surface of the colloidal particles;
(c) loading the printer with an inkjet composition; and
(d) printing on the inkjet recording element using the inkjet composition in response to the digital data signals.
